(19) United States
(12) Patent Application Publication
(10) Pub. No.: US 2023/0034980 A1
(43) Pub. Date: Feb. 2, 2023

(54) CUTTING DEVICE AND METHOD FOR CUTTING AN ELECTRODE FOIL FOR A SECONDARY BATTERY CELL

(71) Applicant: SAMSUNG SDI CO., LTD., Yongin-si (KR)

(72) Inventor: Andrej Golubkov, Graz (AT)

(21) Appl. No.: 17/875,296

(22) Filed: Jul. 27, 2022

(30) Foreign Application Priority Data
Jul. 29, 2021 (EP) 21188378.0
Jul. 27, 2022 (KR) 10-2022-0093412

(51) Int. Cl. H01M 4/04

(52) U.S. Cl. CPC H01M 4/04

(57) ABSTRACT

A cutting device for cutting an electrode foil for a secondary battery cell is provided. The cutting device includes: a cutter configured for cutting an electrode foil; a vacuum configured to intake gas; and an electrostatic field generator. The electrostatic field generator includes a voltage source, a first electrode configured for electrically connecting an electrode foil and a second electrode arranged at a distance from the electrode foil at an inlet opening of the vacuum when the electrode foil is in position to be cut by the cutter.

### CROSS-REFERENCE TO RELATED APPLICATION

This application claims priority to and the benefit of European Patent Application No. 21188378.0, filed in the European Patent Office on Jul. 29, 2021, and Korean Patent Application No. 10-2022-0093412, filed in the Korean Intellectual Property Office on Jul. 27, 2022, the entire content of each of which is incorporated herein by reference.

### BACKGROUND

### 1. Field

Aspects of embodiments of the present disclosure relate to a cutting device for cutting an electrode foil for a secondary battery cell and a method for cutting an electrode foil for a secondary battery cell.

### 2. Description of the Related Art

Recently, vehicles for transportation of goods and peoples have been developed that use electric power as a source for motion. Such an electric vehicle is an automobile that is propelled by an electric motor using energy stored in rechargeable (or secondary) batteries. An electric vehicle may be solely powered by batteries or may be a hybrid vehicle powered by, for example, a gasoline generator. Furthermore, the vehicle may include a combination of an electric motor and a conventional combustion engine.

Generally, an electric-vehicle battery (EVB, or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter provides an irreversible conversion of chemical to electrical energy. Low-capacity rechargeable batteries are used as power supply for small electronic devices, such as cellular phones, notebook computers, and camcorders, while high-capacity rechargeable batteries are used as power supply for hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent group of electric vehicles in development.

Rechargeable batteries may be used as a battery module formed of a plurality of unit battery cells coupled to each other in series and/or in parallel to provide a high energy density, such as for motor driving of a hybrid vehicle. For example, the battery module may be formed by interconnecting the electrode terminals of the plurality of unit battery cells in an arrangement or configuration depending on a desired amount of power and to realize a high-power rechargeable battery.

Battery modules can be constructed in either a block design or a modular design. In the block design, each battery is coupled to a common current collector structure and a common battery management system, and the unit thereof is arranged in a housing. In the modular design, pluralities of battery cells are connected to form submodules, and several submodules are connected to form the battery module. In automotive applications, battery systems often consist of a plurality of battery modules connected to each other in series to provide a desired voltage. The battery modules may include submodules with a plurality of stacked battery cells, and each stack may include cells connected in parallel that are, in turn, connected in series (XpYs) or cells connected in series that are, in turn, connected in parallel (XsYp).

A battery pack is a set of any number of (often identical) battery modules. They may be configured in a series, parallel or a mixture of both to deliver the desired voltage, capacity, or power density. Battery packs include the individual battery modules and the interconnects, which provide electrical conductivity between them.

Lithium-ion cells, or similar secondary battery cells, generally include anode, cathode, and separator foils that are rolled or stacked. An anode electrode foil may be, for example, a copper foil having a thickness in a range of about 8 μm to about 20 μm, which is covered (or coated) with an active anode material, such as graphite, silicon, lithium-titanate. The active anode material is usually coated on both sides of the foil, and the active anode material on each side usually has a thickness of about 50 μm. A cathode electrode foil may be, for example, an aluminum foil, which is similarly covered (or coated) with a cathode active material, such as LFP, NMC, NCA, on both sides. The separator is generally an electrically non-conductive foil having a thickness in a range of about 10 μm to about 30 μm. The separator only conducts ions in the electrolyte solution. The separator may be made of polyethylene (PE), polypropylene (PP), or a copolymer of PE and PP. The battery cell usually also includes a housing or case filled with an electrolyte. The assembly of the anode electrode foil, the cathode electrode foil, and the separator foil is accommodated in the case or housing along with the electrolyte. The electrolyte may be an organic solvent, such as EC (ethylene carbonate), PC (propylene carbonate), DEC (diethyl carbonate), EMC (ethyl methyl carbonate), or DMC (dimethyl carbonate), and a lithium salt, such as lithium hexafluorophosphate (LiPF₆) or lithium tetrafluoroborate (LiBF₄). In addition, the electrolyte may be in a liquid, solid, or gel phase.

During manufacturing, both anode and cathode foils (collectively referred to as “electrode foils”) are cut into the desired shape to fit the cell type. The cutting is generally carried out with a laser cutter. The laser beam is focused on the intended cutting site, causing the material of the electrode foil at the intended cutting site to be vaporized and, thus, cut. However, splatter can form during the laser cutting. The evaporated material and/or the splatter-particles may undesirably fall back and stick on the electrode foil, condense, and accumulate on the surface of the electrode foil. Of course, splatter can also during using other cutting methods, such as mechanical cutting.

When electrode foils that are contaminated by splatter-particles are used in a battery cell, the particles may damage the separator and, thus, may cause an internal short-circuit and self-discharge of the battery cell.

To avoid contamination of the electrode foils during the cutting procedure, the splatter may be transported (e.g., evacuated or moved away) by a gas flow generated by an exhaust hood or an air knife. However, if the gas flow is uneven, for example, splatter may still hit the foil. Thus, using a gas flow to drag away the splatter-particles from the surface of the electrode foil as it is being cut may not ensure the desired quality of the manufactured electrode foils.

### SUMMARY

Embodiments of the present disclosure seek to mitigate and/or solve at least one of the problems existing in the related art to at least some extent. Thus, according to embodiments of the present disclosure provide a cutting device for cutting an electrode foil for a secondary battery cell as well as a method for cutting an electrode foil for a secondary battery cell allowing for an improved quality of the cut electrode foils.

According to a first embodiment of the present disclosure, a cutting device for cutting an electrode foil for a secondary battery cell is provided. The cutting device includes: a cutter configured for cutting an electrode foil; a vacuum configured for the intake of gas; an electrostatic field generator including a voltage source, a first electrode electrically connecting an electrode foil and a second electrode arranged at a distance from the electrode foil at an inlet opening of the vacuum, when the electrode foil is in place to be cut by the cutter.

Thereby, the cutter, the vacuum, and the second electrode may be mounted to have fixed spatial positions relative to each other.

In one embodiment, the second electrode is a grid. The grid may be a planar grid. The grid may have a lattice-like shape formed by, for example, elongated wires arranged in parallel to each other to form elongated spaces between any two adjacent wires. In some embodiments, the grid may have a mesh-like or sieve-like form including, for example, a first group of elongated wires arranged in parallel to each other and a second group of elongated wires arranged in parallel to each other such that the wires of the first group intersect the wires of the second group at an angle, such as an approximately 90° angle.

Electrically charged debris particles pulled by an underpressure and/or an electrostatic field (here and in the following also referred to as an “electric field”) in the direction of the vacuum pass through the openings in the grid and then further into the body of the vacuum. In the immediate vicinity of the grid, the equipotential surfaces of the electric field are essentially parallel to the grid.

In some embodiments of the cutting device, the grid may be planar (e.g., the grid's overall shape may extend on a flat plane). When the electrode foil to be cut is positioned to be planar in the area around the intended cutting site, and the grid is planar and oriented parallel to the area of electrode foil around the intended cutting site, an electric field generated between the grid and the electrode foil will have essentially planar equipotential surfaces, which are parallel to the grid and the area of the electrode foil around the intended cutting site. Thus, the electric force exerted on electrically charged debris particles contaminating the electrode foil's surface as a result of the cutting process is essentially equal around the cutting sited or the intended cutting site.

In one embodiment, the second electrode is positioned between the inlet opening of the vacuum and the position of the electrode foil when the electrode foil is in position to be cut by the cutter.

The closer the second electrode is positioned to the electrode foil to be cut, the stronger is the electric field generated by the electrostatic field generator between the electrode foil and the second electrode (for a fixed voltage, that is, electrical potential, between the first and second electrode). The stronger the generated electric field, the stronger is the force exerted on the electrode foil to be cut, for example, the force by which electrical charged debris is pulled away from the surface of the electrode foil during the cutting procedure (or process).

In one embodiment, the second electrode is positioned in the inlet opening of the vacuum. For example, the second electrode may be mounted at the edge of the inlet opening of the vacuum.

In one embodiment, the second electrode is positioned within the vacuum at a distance (e.g., a predefined distance) from the inlet opening of the vacuum. This may facilitate the mounting of the second electrode.

In one embodiment, the cutter is a mechanical cutter, such as a blade.

In another embodiment, the cutter is a laser configured to generate (and emit) a laser beam suitable for cutting the electrode foil. The laser beam may be pulsed.

In one embodiment, the laser is an infrared laser. The infrared laser may have an output capacity in the range of about 80 W to about 1.5 kW, in the range of about 300 W to about 1.0 kW, and in one embodiment, an output capacity in the range of about 500 W to about 700 W.

In one embodiment, the voltage source is a high voltage (HV) generator. The voltage source may be a direct current (DC) generator. Normally, a constant (high) voltage is applied between the first and the second electrode.

In one embodiment, the voltage source includes a first terminal and a second terminal, and the electric polarity of terminals is reversible.

Whether the first electrode is connected to the positive terminal of the voltage source and the second electrode is connected to the negative terminal of the voltage source or vice-versa, the effect is the same. In other words, the direction of the electric field generated between the electrode foil and the second electrode is generally irrelevant.

However, there may be cases, depending on the material (or material composition) of the electrode foil to be cut, in which the electric field generated between the electrode foil and the second electrode should exhibit a specific orientation (e.g., in which the field lines of the generated electric field either start in the electrode foil and end in the second electrode or vice-versa). Depending thereon, the electrical polarity (positive or negative) of the first and the second electrode should be chosen accordingly.

In one embodiment, the cutting device further includes a holder configured for holding at least an area of the electrode foil. The holder may be arranged in a predefined spatial position with regard to the cutter. The holder may include (or may be) rollers or wheels. Then, by rotating the rollers or wheels, the electrode foil to be cut can be conveyed, piece by piece, relative to the position of the cutter such that an originally rather long piece of the foil material can be cut into a series of smaller pieces having a smaller (e.g., a predetermined) size.

In one embodiment, the vacuum includes a fan or a pump. Thus, gas can be actively moved into the vacuum by the fan or pump. The pump may be a vacuum pump. The gas may be air. In some cases, inert gases, such as He, Ar, N₂ or mixtures, thereof may be used (or may be present). Also, reactive gases, such as O₂, CO₂ or mixtures thereof, or gas mixtures including CO₂ and/or O₂ may be used (or may be present).

In one embodiment, the vacuum includes a connection port configured for establishing a connection with a gas transporter. The vacuum can be connected, via a suitable gas transporter, with an external suction device, such as a pump or fan. The gas transporter may be a hose.

In one embodiment, the cutting device is configured for cutting an electrode foil for a secondary battery cell to be used in a battery for an electric vehicle or a hybrid vehicle.

In one embodiment, the cutting device is configured for cutting an electrode foil for a secondary battery cell to be used in a mobile device, such as a smartphone, a digital camera, a notebook, a tablet computer, or the like.

A second embodiment of the invention provides a method for cutting an electrode foil for a secondary battery cell. The method includes: providing an electrode foil to be cut; holding the electrode foil in a position (e.g., a predefined position); applying an underpressure, by a vacuum, at one side of the electrode foil around an intended cutting site on the electrode foil; electrically connecting the electrode foil with a first electrode of an electrostatic field generator; generating, by the electrostatic field generator, an electrostatic field between the electrode foil and a second electrode of the electrostatic field generator; and cutting the electrode foil at the intended cutting site.

The term “underpressure” shall denote a relative pressure of a gas when it is below the ambient pressure. Then, the pressure difference between the pressure of the gas in the region with underpressure and the pressure of the ambient gas is negative.

The cutting the electrode foil may be executed, while the underpressure is applied and while the electrostatic field is generated. In some embodiments, the underpressure is applied and the electrostatic field is generated at a time. The underpressure may be applied at that side of the electrode foil to be cut, which faces the second electrode.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic perspective view of a battery cell;

FIG. 2 is schematic top-view of two examples of a vacuum;

FIG. 3 is a schematic sectional view of a cutting device according to a first embodiment;

FIG. 4 is a schematic sectional view of a cutting device according to a second embodiment;

FIG. 5 is a schematic sectional view of a cutting device according to a third embodiment;

FIG. 6 is a schematic sectional view of a cutting device according to a forth embodiment; and

FIG. 7 is a schematic sectional view of a cutting device according to a fifth embodiment.

### DETAILED DESCRIPTION

Reference will now be made in detail to embodiments, examples of which are illustrated in the accompanying drawings. Aspects and features of the embodiments, and implementation methods thereof, will be described with reference to the accompanying drawings. In the drawings, like reference numerals denote like elements, and redundant descriptions thereof may be omitted.

As used herein, the term “and/or” includes any and all combinations of one or more of the associated listed items. Further, the use of “may” when describing embodiments of the present invention refers to “one or more embodiments of the present invention.”

It will be understood that although the terms “first,” “second,” etc. are used to describe various elements, these elements should not be limited by these terms. These terms are only used to distinguish one element from another element. For example, a first element may be named a second element and, similarly, a second element may be named a first element, without departing from the scope of the present disclosure.

In the following description of embodiments of the present invention, the terms of a singular form may include plural forms unless the context clearly indicates otherwise. Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be further understood that the terms “have,” “include,” “comprise,” “having,” “including,” and/or “comprising,” and other variations thereof, specify a property, a region, a fixed number, a step, a process, an element, a component, and a combination thereof but do not exclude other properties, regions, fixed numbers, steps, processes, elements, components, and combinations thereof.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

It will also be understood that when a film, a region, or an element is referred to as being “above” or “on” another film, region, or element, it can be directly on the other film, region, or element, or intervening films, regions, or elements may also be present.

Herein, the terms “upper” and “lower” are defined with reference to the z-axis as shown in the Figures. For example, the upper cover is positioned at the upper part of the z-axis, and the lower cover is positioned at the lower part thereof. It will be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

In the drawings, the sizes of elements may be exaggerated for clarity. For example, in the drawings, the size or thickness of each element may be arbitrarily shown for illustrative purposes, and thus, embodiments of the present disclosure should not be construed as being limited thereto.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

FIG. 1 is a perspective view of a secondary battery cell 100. The battery cell 100 may be a lithium-ion cell. The battery cell 100 includes a first electrode foil 110, a second electrode foil 120, and a separator foil 130 interposed between the first electrode foil 110 and the second electrode foil 120. The battery cell 100 is configured such that a stacked structure of the first electrode foil 110, the second electrode foil 120, and the separator foil 130 is wound in a jelly-roll configuration. In one embodiment, the first electrode foil 110 may function as an anode, and the second electrode foil 120 may function as a cathode. A first collector tab 115 is attached to the first electrode foil 110, and a second collector tab 125 is attached to the second electrode foil 120. The first collector tab 115 and the second collector tab 125 act as terminals of the battery cell 100. The separator foil 130 positioned between the first electrode foil 110 and the second electrode foil 120 to prevent electrical shorts therebetween and to allow movement of lithium ions. The assembly of the first electrode foil 110, the second electrode foil 120, and the separator foil 130 is accommodated in a case (or housing) along with an electrolyte.

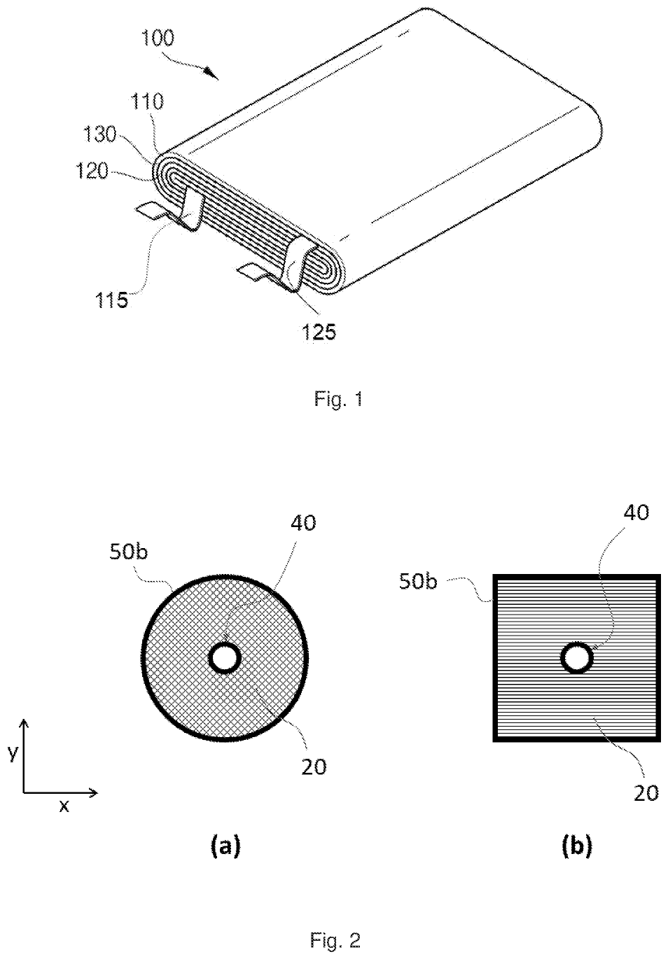

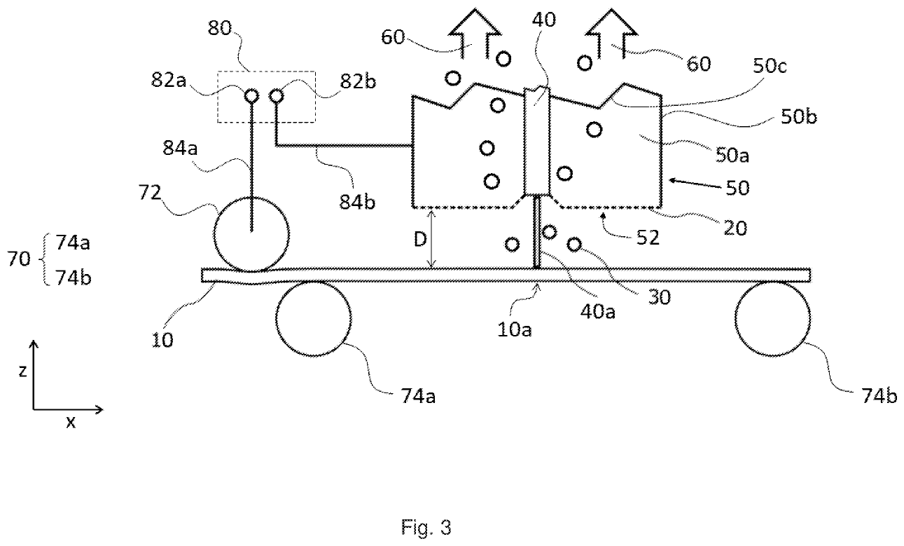

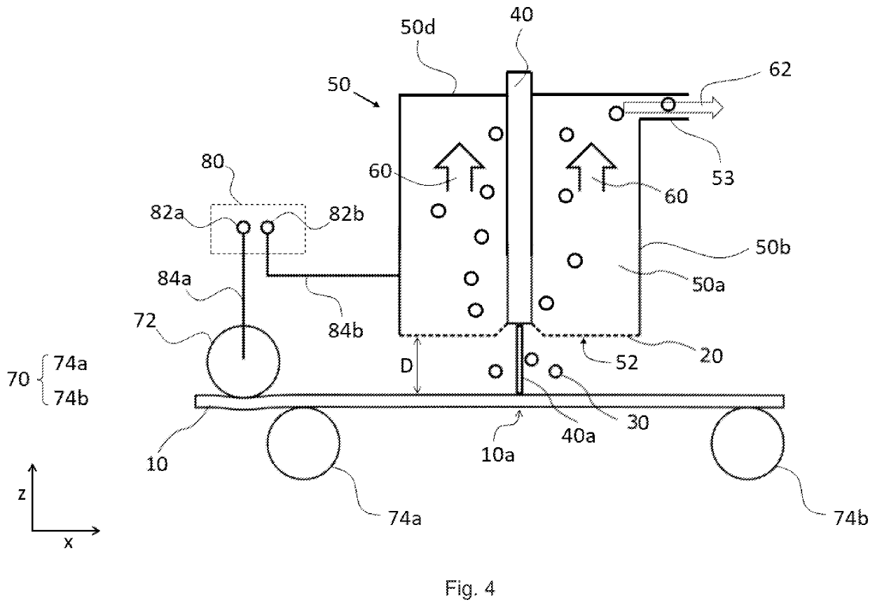

FIG. 3 is a schematic sectional view of a first embodiment of a cutting device according to the present disclosure. An area of an electrode foil 10 for the first electrode foil 110 or the second electrode foil 120 to be cut by the cutting device is shown in the figure. To facilitate the description, a coordinate system with the orthogonal axes x and z is also depicted in FIG. 3 as well as in the following FIGS. 4-7. The cutting device includes a laser 40 configured to generate (e.g., to emit) a laser beam 40a, a vacuum 50, and an electrostatic field generator. The laser 40 is arranged within the interior 50a of the vacuum 50 such that a laser beam 40a generated by the laser 40 is orientated in the −z-axis direction of the coordinate system. In FIG. 3, a tube or pipe 50b of the vacuum 50 having an inlet opening 52 at its bottom side is shown. The cross-section of the tube 50b in a plane perpendicular to the z-axis may be circular (see, e.g., FIG. 2 (a)) or rectangular (see, e.g., FIG. 2 (b)); however, other cross-sectional shapes are also possible, provided the inlet opening 52 of the tube 50b is arranged at its bottom side. The upper side of the vacuum 50 is not shown in FIG. 3, which is indicated by the zig-zag line 50c. By an arrangement as described above, the laser beam 40a generated by the laser 40 will be emitted downwardly (e.g., in the −z-axis direction) from the inlet opening 52 of the vacuum 50.

Further, the area of the electrode foil 10 shown in FIG. 3 is held in a position by a holder 70 including (or in the form of) rollers or wheels 74a, 74b. The rollers or wheels 74a, 74b are configured to transport (e.g., move) the electrode foil 10 in or against the x-axis direction as shown in the coordinate system and to fasten the electrode foil 10 in a position such that an intended cutting site 10a (e.g., a spot or portion of the electrode foil 10 to be cut by the cutting device) is located directly below the laser 40. In FIG. 3, the electrode foil 10 is illustrated as being supported by two supporting rollers or wheels 74a, 74b.

A grid 20 including (or made of) a conductive material is arranged directly in the inlet opening 52 of the vacuum 50 (e.g., at the bottom end of the tube 50b). The conductive material may be metal. The grid 20 essentially extends in a flat plane perpendicular to the z-axis and completely covers the inlet opening 52 of the vacuum 50 except for the area in which the laser 40 is arranged or at least except for an area through which the laser beam 40a generated by the laser 40 may pass. Example arrangements are schematically illustrated in FIG. 2. For example, FIG. 2 shows two examples of the grid 20 in a top view, with the grid 20 being mounted into the (inlet opening of) tube 50b. The y-axis of the coordinates system in FIG. 2 is orientated orthogonal to both the x-axis and the z-axis as shown in FIGS. 3-7. In the example shown in FIG. 2(a), the grid 20 is formed in mesh-like or sieve-like manner, for example, a first group of elongated wires are arranged in parallel to each other to intersect at or about a 90 degree angle, the wires of a second group of elongated wires also arranged in parallel to each other. In FIG. 2(a), the cross-section of the tube 50b of the vacuum 50 has a circular shape. In the example shown in FIG. 2(b), the grid 20 is formed in a lattice-like fashion, for example, elongated wires are arranged in parallel to each other so as to form elongated spaces between any two adjacent wires. In FIG. 2(b), the cross-section of the tube 50b of the vacuum 50 has a quadratic (e.g., square or rectangular) shape.

However, depending on the spatial position of the laser 40 arranged in the vacuum 50, the grid 20 may be bent upwardly or downwardly in an area around the lower end of the laser 40. In the embodiment of the cutting device shown in FIG. 3, the grid 20 is slightly bent upwardly so as to come into contact (spatially) with the bottom end of the laser 40. This way, any particle sucked from below into the vacuum 50 must pass through the grid 20, in particular, through one of the numerous openings formed by the grid 20 (shown by the gaps of the dashed line illustrating the grid 20 in FIG. 3).

The electrostatic field generator includes a voltage source 80, for example, a high voltage (HV) generator. The voltage source 80 includes a first terminal 82a and a second terminal 82b. In the embodiment shown in FIG. 3, the tube 50b of the vacuum 50 and a third roller or wheel 72 are made of a conductive material, such as a metal. The first terminal 82a is electrically connected to the third roller or wheel 72 by a first electric connection 84a (e.g., a cable). Similarly, the second terminal 82b is electrically connected to the tube 50b, which is in turn electrically connected to the conductive grid 20, by a second electrical connection 84b (e.g., a cable). Thus, the third roller or wheel 72 and the grid 20 act as a first electrode and a second electrode, respectively, when a voltage is provided by the voltage source 80.

When the electrode foil 10 to be cut is held in position as depicted in FIG. 3, the intended cutting site 10a is placed directly below the laser 40 such that the laser beam 40a ejected (or emitted) from the laser 40 will impinge upon the intended cutting site 10a on the upper side of the electrode foil 10. The material of the electrode foil to be cut vaporizes at the intended cutting site 10a due to the laser beam 40a focused on the intended cutting site 10a and, eventually, the electrode foil 10 will be cut at the cutting site 10a.

However, splatter-particles 30 made of material expelled from the cutting site 10a are normally formed during this procedure.

To prevent the splatter-particles 30 from falling back onto the electrode foil 10, an underpressure is generated in the gas atmosphere at an upper side of electrode foil 10 in the area around the cutting site 10a. The underpressure is generated by intaking gas into the vacuum 50, which is indicated in the figure by the upwardly directing arrows 60. Due to the vacuum cleaner effect, splatter-particles 30 will be entrained with the upwardly directed drag of the gas generated above the upper surface of the electrode foil 10 and will be, eventually, discharged from the area around the cutting site 10a. The gaps in grid 20 are formed to have a suitable size such that any or at least a majority of splatter-particles 30 can pass through the grid 20 (note that, in the drawings, the sizes of the splatter-particles 30 are depicted in an exaggerated fashion in comparison to the sizes of the gaps in the grid 20 indicated by the intervals in the dashed line used for drawing the grid 20 for the sake of recognizability.)

However, if the gas flow generated by the vacuum 50 is uneven, for example, some splatter-particles 30 may still drop down again onto the electrode foil 10. To prevent this, the upwardly directed force acting on the splatter-particles 30 caused by the gas flow formed by the vacuum 50 is amplified by an electrostatic force. The electrostatic force is generated by the electrostatic field generator. For example, an electrical potential difference is generated by the voltage source 80 between its first and second terminals 82a, 82b. Due to the electrical connections as described above, the third roller or wheel 72, which presses against the electrode foil 10 from above, acts as an electrode transferring the electrical potential of the first terminal 82a of the voltage source 80 to the electrode foil 10. On the other hand, the electrically conductive tube 50b of the vacuum 50 is kept at the same electrical potential as the second terminal 82b offer voltage source 80. Because the electrically conductive grid 20 is connected to the edge of the inlet opening 52 of the tube 50b, its electrical potential is also kept the same (e.g., on the same level) as that of the second terminal 82b.

Consequently, an electric field is formed between the grid 20 and the electrode foil 10. In the embodiment illustrated in FIG. 3, the grid 20 extends essentially planar and parallel to the surface of the electrode foil 10 between the two supporting rollers or wheels 74a, 74b. The upper surface of the electrode foil 10 is held at a distance (e.g., a predefined distance) D from the grid 20. Accordingly, the generated electric field exhibits essentially planar equipotential surfaces in the area around the cutting site 10a. Thus, in this area, the electrostatic force exerted on a splatter-particle 30 on or close to the upper surface of the electrode foil 10 is essentially constant independent (or irrespective) of the exact location relative to the cutting site 10a.

Because the splatter-particles have been struck off (e.g., formed and emitted), due to the cutting procedure, from the electrode foil 10 while it has been kept at the electric potential of the first terminal 82a of the voltage source 80, the splatter-particles 30 each carry a corresponding electric charge that causes, in the electric field generated between the electrode foil 10 and the grid 20, an upwardly directed force acting on the splatter-particles 30. For example, the splatter-particles 30 are attracted to the grid 20 and repelled by the electrode foil 10. Thus, the splatter-particles 30 move up in the electric field (e.g., in the z-axis direction of the depicted coordinate system). Hence, the forces exerted on the splatter-particles 30 by the electric field amplify the forces that already act on the splatter-particles 30 due to the gas flow caused by the vacuum 50. In other words, the combination of electrostatic forces and drag by the gas flow improves the removal of the splatter-particles 30. Normally, the above-described effects are independent of the chosen electric polarity of the electrodes (e.g., the electric polarity does usually not play a meaningful role) whether the first terminal 82a of the voltage source 80 is the PLUS (or positive) terminal and the second terminal 82b is the MINUS (or negative) terminal or whether the polarity of the terminals 82a, 82b is reversed.

The electric field is not present in the area above the grid 20. However, due to the velocity the splatter-particles 30 imparted thereto while they move up in the electric field in the area between the electrode foil 10 and the grid 20, and also by the dragging force caused by the gas flow, which is still present at the grid 20 and above the grid 20, the splatter-particles 30 pass through the gaps in the grid 20 are further sucked into the tube 50b of the vacuum 50 and are finally discharged.

FIG. 4 illustrates a schematic sectional view of a cutting device according to a second embodiment of the present disclosure. The assembly of this embodiment largely corresponds to the assembly of the first embodiment, which has been described above. However, in the second embodiment, the top of the tube 50b of the vacuum 50 is closed in a gas-tight manner by a top cover 50d. Further, the vacuum 50 includes a connection port 53 arranged in the top area of the tube 50b. An external suction device, such as a vacuum pump, can thus be coupled with the vacuum 50, for example, via a hose connected to the connection port 53. Then, an underpressure is generated by the external suction device within the interior 50a of the vacuum 50. Finally, due to the underpressure within the interior 50a of the vacuum 50, a gas flow is generated in the area below the inlet opening 52 of the vacuum 50 (e.g., in the area between the electrode foil 10 and the grid 20). The removal of the splatter material 30 caused by the cutting process has been described above in detail in the context of the first embodiment shown in FIG. 3. For example, in this embodiment, the splatter-particles 30 are discharged from the cutting device via the connection port 53 as indicated by the arrow 62.

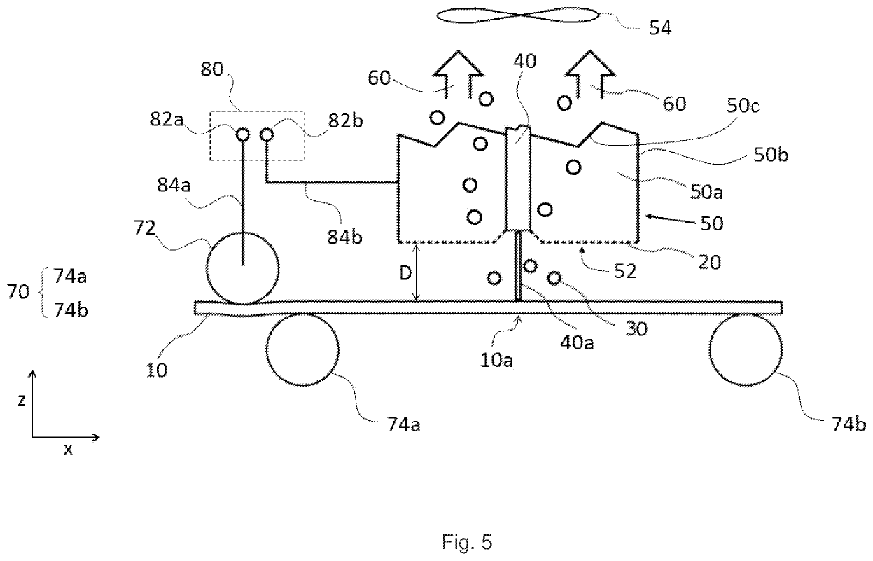

A cross-sectional view of a third embodiment of the cutting device according to the present disclosure is shown in FIG. 5. The basic construction of the third embodiment again corresponds to that described above in the context of a first embodiment shown in FIG. 3. In contrast to the second embodiment shown in FIG. 4, the vacuum 50 includes a fan 54 to generate an underpressure within the interior 50a of the vacuum 50. The fan 54 may be arranged within the tube or pipe 50b of the vacuum 50. The fan 54, and its location, is schematically indicated in FIG. 5. By rotating the fan 54 in a suitable manner, ambient gas is sucked from the area below the inlet opening 52 in the z-axis direction of the illustrated coordinate system. Accordingly, gas is drawn from the area between the electrode foil 10 and the grid 20 through the grid 20 arranged in the inlet opening 52. Thus, different from the second embodiment shown in FIG. 4, the vacuum 50 according to the third embodiment is configured to actively generate underpressure and, as a consequence thereof, upwardly directed gas flow in the area above the upper surface of the electrode foil 10 around the cutting site 10a. The removal of the splatter material 30 caused by the cutting process has been described above in detail in the context of the first embodiment shown in FIG. 3.

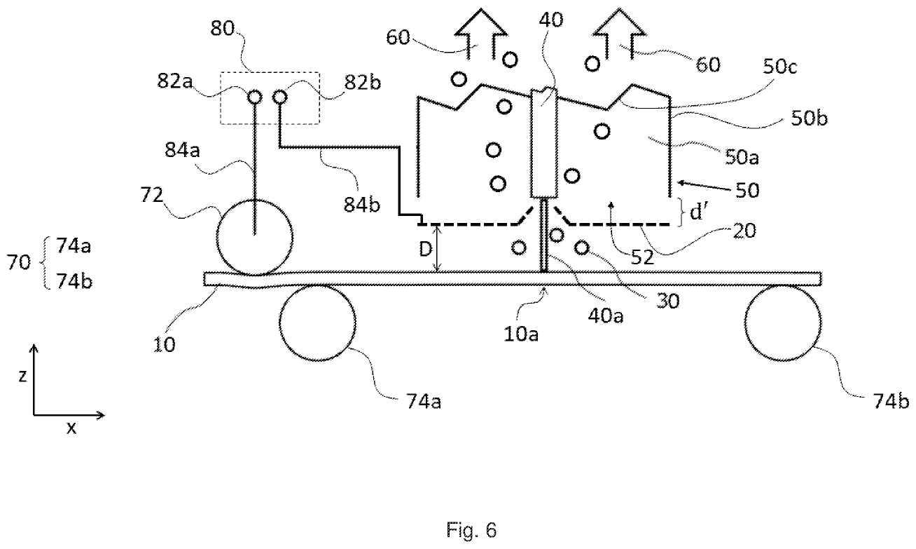

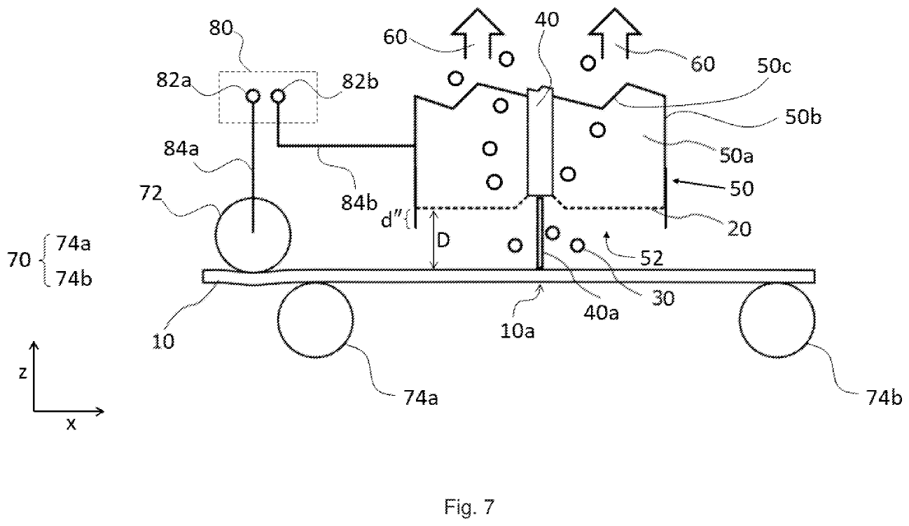

FIGS. 6 and 7 schematically illustrate two additional embodiments of the cutting device according to the present disclosure, which differ from the first embodiment illustrated in FIG. 3 by the position which the grid 20 is arranged with respect to the vacuum 50 and also with respect to the position of the electrode foil 10. In this way, the distance between the electrode foil 10 and the inlet opening 52 of the vacuum 50 (which influences the strength of the gas flow at the surface of the electrode foil 10) can be adjusted independently from the distance D between the electrode foil 10 and the grid 20, which influences the strength of the electric field present at the surface of the electrode foil 10. Except for the spatial arrangement of the grid 20, the embodiments shown in FIGS. 6 and 7 correspond essentially to the construction of the first embodiment illustrated in FIG. 3.

In FIG. 6, the grid 20 is arranged beneath the inlet opening 52 of vacuum 50 at a distance d′ from the latter. Accordingly, the gradient of the electric field generated between the electrode foil 10 and the grid 20 is increased when the distance D between the electrode foil 10 and the grid 20 is decreased in comparison to the embodiment shown in FIG. 3 (provided that, in both embodiments, the same potential difference is applied between the first electrode and the second electrode by the voltage source 80), which leads to a stronger electric force acting on charged particles, such as splatter, in the vicinity of the surface of the electrode foil 10. Also, because there is no connection between the grid 20 and the tube 50b of the vacuum 50, only the grid 20 needs to be kept at the level of the electric potential of the second terminal 82b of the voltage source 80 (e.g., the grid 20 is directly connected by the wire 84b to the second terminal 82b). The tube 50b of the vacuum 50 can, thus, be held at a neutral electric potential (e.g., the tube 50b can be grounded) if the tube 50b is made of a conductive material, such as a metal. In other embodiments, the tube 50b may be made of a non-conductive material, such as a plastic.

Additionally, in a variation of the first embodiment shown in FIG. 3, the grid 20 can be electrically isolated from the tube 52b and directly connected to the second terminal 82b of the voltage source 80. In such an embodiment, an isolator may be used when mounting the grid 20 into the inlet opening 52 as shown in FIG. 3, or the tube 52b may be made of a non-conductive material.

According to a fifth embodiment, as illustrated in FIG. 7, the grid 20 is arranged within the tube 50b of the vacuum 50 at a distance d″ above the inlet opening 52 of the vacuum 50. The grid 20 is electrically connected to the second terminal 82b of the voltage source 80 via, for example, the tube 50b, as shown in FIG. 7. In other embodiments, the grid 20 may be directly electrically connected to the second terminal 82b in the manner as shown in, for example, FIG. 6. In such an embodiment, the tube 50b may be grounded (if it is made of a conductive material) or may be made of a non-conductive material. In the embodiment shown in FIG. 7, the inlet opening 52 of the tube 50b can be brought closer to the upper surface of the electrode foil 10, increasing the gas flow and, thus, imparting a stronger mechanical force onto the debris, such as splatter present on (or over) the upper surface of the electrode foil 10. Also, the mounting of the grid 20 according to this embodiment may be easier in comparison to the arrangement of the first embodiment.

### SOME REFERENCE SYMBOLS

10 electrode foil
10a cutting site
20 grid/second electrode
30 splatter-particles
40 laser
40a laser beam
50 vacuum
50a interior of the vacuum
50b tube or pipe
50c zig-zag line indicating that the tube extends further
50d top-cover
52 inlet opening
53 connection port
54 fan
60, 62 arrows indicating a direction of a gas flow
70 rollers or wheels
74a, 74b supporting rollers or wheels
72 third roller or wheel/first electrode
80 voltage source
82a, 82b terminals
84a, 84b electric connections
100 battery cell
110 first electrode foil
120 second electrode foil
130 separator foil
115 first collector tab connected to the first electrode foil
125 second collector tab connected to the second electrode foil
x, y, z axes of a coordinate system

What is claimed is:

1. A cutting device for cutting an electrode foil for a secondary battery cell, the cutting device comprising:
a cutter configured for cutting an electrode foil;
a vacuum configured to intake gas; and
an electrostatic field generator comprising a voltage source, a first electrode configured for electrically connecting an electrode foil and a second electrode arranged at a distance from the electrode foil at an inlet opening of the vacuum when the electrode foil is in position to be cut by the cutter.

2. The cutting device according to claim 1, wherein the second electrode is a grid.

3. The cutting device according to claim 2, wherein the second electrode is a planar grid.

4. The cutting device according to claim 1, wherein the second electrode is between the inlet opening of the vacuum and the electrode foil when the electrode foil is in the position to be cut.

5. The cutting device according to claim 1, wherein the second electrode is in the inlet opening of the vacuum.

6. The cutting device according to claim 1, wherein the second electrode is within the vacuum at a distance from the inlet opening of the vacuum.

7. The cutting device according to claim 1, wherein the cutter is a mechanical cutter.

8. The cutting device of claim 7, wherein the mechanical cutter is a blade.

9. The cutting device according to claim 1, wherein the cutter is a laser configured to generate a laser beam for cutting the electrode foil.

10. The cutting device according to claim 9, wherein the laser is an infrared laser, and
wherein the infrared laser has an output capacity in a range of 80 W to 1.5 kW.

11. The cutting device according to claim 10, wherein the infrared laser has an output capacity in a range of 300 W to 1.0 kW.

12. The cutting device according to claim 10, wherein the infrared laser has an output capacity in a range of 500 W to 700 W.

13. The cutting device according to claim 1, wherein the voltage source is a high voltage generator.

14. The cutting device according to claim 13, wherein the voltage source comprises a first terminals and a second terminal, and
wherein an electric polarity of the first and second terminals is reversible.

15. The cutting device according to claim 1, further comprising a holder holding at least an area of the electrode foil.

16. The cutting device according to claim 1, wherein the vacuum comprises a fan or a pump.

17. The cutting device according to claim 16, wherein the vacuum comprises a connection port configured for establishing a connection with a gas transporter.

18. The cutting device for cutting an electrode foil for a secondary battery cell according to claim 1, wherein the secondary battery cell is configured to be used in a battery for an electric vehicle or a hybrid vehicle.

19. The cutting device for cutting an electrode foil for a secondary battery cell according to claim 1, wherein the secondary battery cell is configured to be used in a mobile device.

20. A method for cutting an electrode foil for a secondary battery cell, the method comprising:
holding an electrode foil in a position;
applying, by a vacuum, an underpressure at one side of the electrode foil around an intended cutting site on the electrode foil;
electrically connecting the electrode foil with a first electrode of an electrostatic field generator;
generating, by the electrostatic field generator, an electrostatic field between the electrode foil and a second electrode of the electrostatic field generator; and
cutting the electrode foil at the intended cutting site.
